(19) United States
(12) Patent Application Publication
(10) Pub. No.: US 2017/0133885 A1
(43) Pub. Date: May 11, 2017

(54) NOTCH FILTER UTILIZED FOR NEAR FIELD COMMUNICATION AND WIRELESS POWER TRANSFER DUAL MODE ANTENNAS

(71) Applicant: QUALCOMM Incorporated, San Diego, CA (US)

(72) Inventor: Sheng-Kuan Chen, Taoyuan City (TW)

(21) Appl. No.: 15/092,249

(22) Filed: Apr. 6, 2016

Related U.S. Application Data
(60) Provisional application No. 62/252,259, filed on Nov. 6, 2015.

(51) Int. Cl. H02J 50/12; H04B 5/00; H02J 7/02

(52) U.S. Cl. CPC H02J 50/12; H02J 7/025; H04B 5/0037

(57) ABSTRACT

One aspect of the disclosure provides an apparatus for wirelessly coupling with other devices including an antenna, wireless power circuitry configured to receive wireless power from the antenna at a first frequency, communication circuitry coupled to the antenna and configured to receive a signal from the antenna at a second frequency different from the first frequency, and a filter circuit coupled between the antenna and an input of the wireless power circuitry, the filter circuit configured to electrically connect the wireless power circuitry to the antenna at the first frequency and electrically isolate the wireless power circuitry from the communication circuitry at the second frequency.

### CLAIM OF PRIORITY UNDER 35 U.S.C. §119

The present application for patent claims priority to Provisional Application No. 62/252,259 entitled “NOTCH FILTER UTILIZED FOR NEAR FIELD COMMUNICATION AND WIRELESS POWER TRANSFER DUAL MODE ANTENNAS” filed Nov. 6, 2015, and assigned to the assignee hereof. Provisional Application No. 62/252,259 is hereby expressly incorporated by reference herein.

### FIELD

Certain aspects of the present disclosure generally relate to wireless power transfer, and more particularly, notch filters utilized for near field communications (NFC) and wireless power transfer dual-mode antennas.

### BACKGROUND

Wireless power charging systems may provide the ability to charge and/or power mobile electronic devices without physical, electrical connections, thus reducing the number of components required for operation of the electronic devices and simplifying the use of the electronic device. It is desirable to incorporate wireless power circuitry and NFC dual mode antennas into such devices.

### SUMMARY

One aspect of the disclosure provides an apparatus for wirelessly coupling with other devices. The apparatus includes an antenna. The apparatus includes wireless power circuitry configured to receive wireless power from the antenna at a first frequency. The apparatus includes communication circuitry coupled to the antenna and configured to receive a signal from the antenna at a second frequency different from the first frequency. The apparatus includes a filter circuit coupled between the antenna and an input of the wireless power circuitry, the filter circuit configured to electrically connect the wireless power circuitry to the antenna at the first frequency and electrically isolate the wireless power circuitry from the communication circuitry at the second frequency.

Another aspect of the disclosure provides a method for wirelessly coupling an electronic device with other devices. The method includes electrically coupling, by a filter circuit, wireless power circuitry to an antenna at a first frequency and electrically isolating, by the filter circuit, the wireless power circuitry from communication circuitry coupled to the antenna at a second frequency different from the first frequency, the filter circuit coupled between the antenna and an input of the wireless power circuitry. The method includes receiving wireless power by the wireless power circuitry from the antenna at the first frequency. The method includes receiving a signal by the communication circuitry from the antenna at the second frequency.

Another aspect of the disclosure provides a method for manufacturing an electronic device for wirelessly coupling with other devices. The method comprises providing an antenna. The method comprises providing wireless power circuitry configured to receive wireless power from the antenna at a first frequency. The method comprises connecting communication circuitry to the antenna, the communication circuitry configured to receive a signal from the antenna at a second frequency. The method comprises connecting a filter circuit between the wireless power circuitry and the antenna, the filter circuit configured to electrically connect the wireless power circuitry to the antenna at the first frequency and electrically isolate the wireless power circuitry from the communication circuitry at the second frequency.

Another aspect of the disclosure provides an apparatus for wirelessly coupling with other devices. The apparatus includes means for generating a voltage under the influence of an alternating magnetic field. The apparatus comprises means for receiving wireless power at a first frequency from the means for generating the voltage. The apparatus comprises means for receiving a signal from the means for generating the voltage at a second frequency different from the first frequency. The apparatus comprises means for electrically connecting the means for receiving wireless power to the means for generating a voltage at the first frequency and electrically isolating the means for receiving wireless power from the means for receiving the signal at the second frequency. The means for electrically connecting is connected between the means for generating a voltage and an input of the means for receiving wireless power.

### BRIEF DESCRIPTION OF THE DRAWINGS

FIG. 1 is a functional block diagram of a wireless power transfer system, in accordance with an exemplary implementation.

FIG. 2 is a functional block diagram of a wireless power transfer system, in accordance with another exemplary implementation.

FIG. 3 is a schematic diagram of a portion of the transmit circuit or the receive circuit of FIG. 2 including a transmit coupler or a receive coupler, in accordance with an exemplary implementation.

FIG. 4 illustrates a block diagram of a dual mode antenna and related communication and wireless power circuitry, in accordance with some implementations.

FIG. 5 illustrates a hybrid schematic/block diagram of a dual mode antenna and related communication and wireless power circuitry, in accordance with some implementations.

FIG. 6 illustrates another hybrid schematic/block diagram of a dual mode antenna and related communication and wireless power circuitry, in accordance with some implementations.

FIG. 7A illustrates a graph of a rectifier resistance as a function of a load resistance, in accordance with some implementations.

FIG. 7B illustrates a graph of a rectifier reactance as a function of a load resistance, in accordance with some implementations.

FIG. 8 illustrates another hybrid schematic/block diagram of a dual mode antenna and related communication and wireless power circuitry, in accordance with some implementations.

FIG. 9 illustrates an impedance versus frequency curve and a frequency response curve for the NFC matching network shown in FIG. 8, in accordance with some implementations.

FIG. 10 illustrates another hybrid schematic/block diagram of a dual mode antenna and related communication and wireless power circuitry, in accordance with some implementations.

FIG. 11 illustrates impedance versus frequency curves for the NFC matching network shown in FIG. 10, in accordance with some implementations.

FIG. 12 is a flow chart for a method for wirelessly coupling an electronic device with other devices, in accordance with some implementations.

FIG. 13 is a flow chart for a method manufacturing an electronic device for wirelessly coupling with other devices, in accordance with some implementations.

### DETAILED DESCRIPTION

Various aspects of the novel systems, apparatuses, and methods are described more fully hereinafter with reference to the accompanying drawings. The teachings of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, access networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

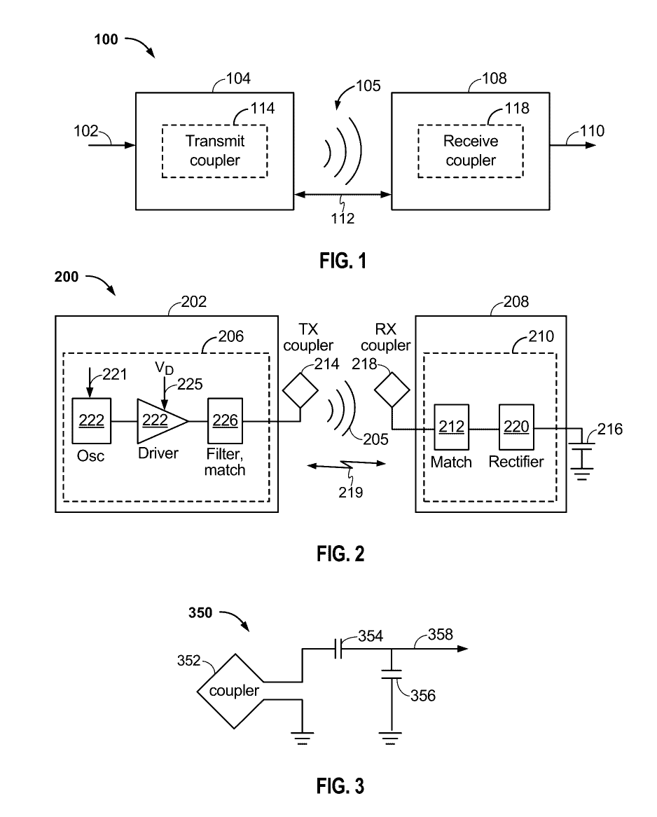

FIG. 1 is a functional block diagram of a wireless power transfer system 100, in accordance with an exemplary implementation. Input power 102 may be provided to a transmit coupler 114 of a transmitter 104 from a power source (not shown) to generate a wireless (e.g., magnetic or electromagnetic) field 105 for performing energy or power transfer. The wireless field 105 corresponds to a region where energy output by the transmitter 104 may be captured by a receiver 108. A receive coupler 118 (e.g., a receive coupler 118) of the receiver 108 may couple to the wireless field 105 and may generate output power 110 for storing or consumption by a device (not shown) coupled to the output power 110. Both the transmitter 104 and the receiver 108 may be separated by a distance 112.

In one exemplary implementation, power is transferred inductively via a time-varying magnetic field generated by the transmit coupler 114. The transmit coupler 114 and the receive coupler 118 may be configured according to a mutual resonant relationship. When the resonant frequency of the receive coupler 118 and the resonant frequency of the transmit coupler 114 are substantially the same, or very close, transmission losses between the transmitter 104 and the receiver 108 are minimal. Resonant inductive coupling techniques may thus allow for improved efficiency and power transfer over various distances and with a variety of coupler configurations.

In some implementations, the wireless field 105 corresponds to the “near-field” of the transmitter 104. The “near-field” may correspond to a region in which there are strong reactive fields resulting from the currents and charges in the transmit coupler 114 that minimally radiate power away from the transmit coupler 114, rather than radiating electromagnetic energy away into free space. The “near-field” may correspond to a region that is within about one wavelength (or a fraction thereof) of the transmit coupler 114.

Efficient energy transfer may occur by coupling a large portion of the energy in the wireless field 105 to the receive coupler 118 rather than propagating most of the energy in an electromagnetic wave to the far field. When positioned within the wireless field 105, a “coupling mode” may be developed between the transmit coupler 114 and the receive coupler 118.

FIG. 2 is a functional block diagram of a wireless power transfer system 200, in accordance with some other exemplary implementation. The system 200 includes a transmitter 202 and a receiver 208. The transmitter 204 includes transmit circuitry 206 that includes an oscillator circuit 222, a driver circuit 224, and a filter and matching circuit 226. The oscillator circuit 222 is configured to generate a signal at a desired frequency that may be adjusted in response to a frequency control signal 221. The oscillator circuit 222 provides the oscillator signal to the driver circuit 224. The driver circuit 224 is configured to drive the transmit coupler 214 at, for example, a resonant frequency of the transmit coupler 218 based on an input voltage signal (V_{D}) 225. The filter and matching circuit 226 filters out harmonics or other unwanted frequencies and may also match the impedance of the transmit circuitry 206 to the impedance of the transmit coupler 214 for maximal power transfer. The driver circuit 224 drives a current through the transmit coupler 214 to generate a wireless field 205 for wirelessly outputting power at a level sufficient for charging a battery 216.

The receiver 208 comprises receive circuitry 210 that includes a matching circuit 212 and a rectifier circuit 220. The matching circuit 212 may match the impedance of the receive circuitry 210 to the impedance of the receive coupler 218. The rectifier circuit 220 may generate a direct current (DC) power output from an alternate current (AC) power input to charge the battery 216. The receiver 208 and the transmitter 204 may additionally communicate on a separate communication channel 219 (e.g., NFC, Bluetooth, Zigbee, cellular, etc). The receiver 208 and the transmitter 204 may alternatively communicate via band signaling using characteristics of the wireless field 205. The receiver 208 may be configured to determine whether an amount of power transmitted by the transmitter 204 and received by the receiver 208 is appropriate for charging the battery 216.

FIG. 3 is a schematic diagram of a portion of the transmit circuitry 206 or the receive circuitry 210 of FIG. 2, in accordance with some exemplary embodiments. As illustrated in FIG. 3, transmit or receive circuitry 350 may include a coupler 352. The coupler 352 may also be referred to or be configured as a “conductor loop”, a coil, an inductor, an antenna, or as a “magnetic” coupler. The term “coupler” generally refers to a component that may wirelessly output or receive energy for coupling to another “coupler.”

The resonant frequency of the loop or magnetic couplers is based on the inductance and capacitance of the loop or magnetic coupler. Inductance may be simply the inductance created by the coupler 352, whereas, capacitance may be added via a capacitor (or the self-capacitance of the coupler 352) to create a resonant structure at a desired resonant frequency. As a non-limiting example, a capacitor 354 and a capacitor 356 may be added to the transmit or receive circuitry 350 to create a resonant circuit that resonates at a resonant frequency. For larger sized couplers using large diameter coils exhibiting larger inductance, the value of capacitance needed to produce resonance may be lower. Furthermore, as the size of the coupler increases, coupling efficiency may increase. This is mainly true if the size of both base and electric vehicle couplers increase. For transmit couplers, the signal 358, with a frequency that substantially corresponds to the resonant frequency of the coupler 352, may be an input to the coupler 352. For receive couplers, the signal 358 may be the output from the coupler 352.

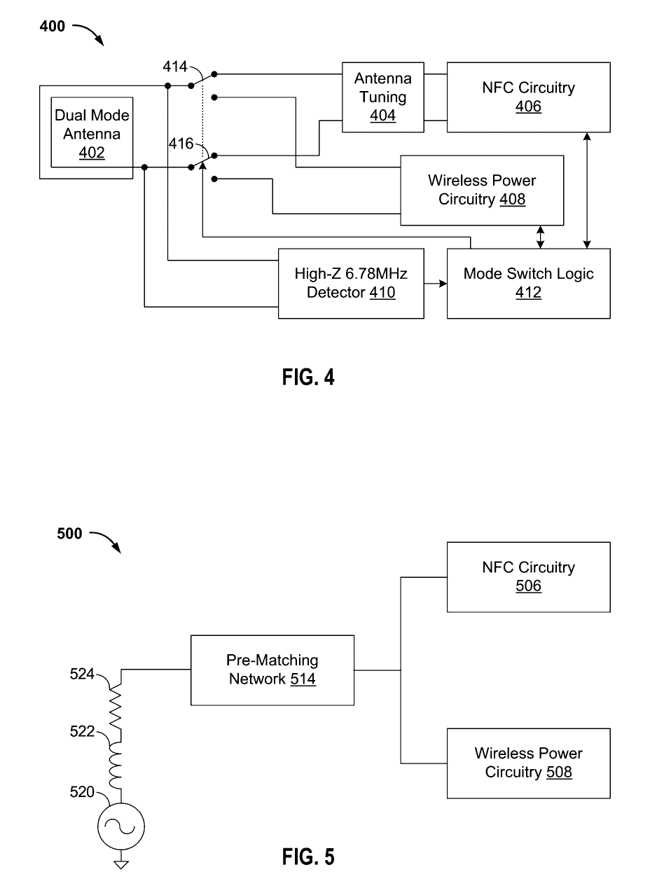

Some mobile devices include the capability to both communicate wirelessly (e.g., via near field communication (NFC)) and to receive charging power wirelessly (e.g., via one or more wireless charging protocols). For such mobile devices, it may be desirable to provide a single antenna that is configurable to function as a receive antenna for both systems, e.g., a dual mode antenna. Such implementations allow reuse of at least the receive antenna, which may reduce manufacturing costs. However, NFC and many wireless charging protocols operate at different frequencies. For example, in some implementations, NFC technology may operate at 13.56 MHz and within a range of magnetic field strengths of between 1.5 A/m and 7.5 A/m having a magnetic field strength threshold of 0.1875 A/m. Contrarily some wireless power technologies may operate at 6.78 MHz at a maximum magnetic field strength of 60 A/m. Thus, it is also desirable that filtering circuitry between such a dual mode antenna and each of the NFC circuitry and the wireless charging circuitry be able to adequately attenuate or reject frequency content associated with the other circuitry. For example, a filter between the wireless power circuitry and the receive antenna should be configured to substantially attenuate or reject NFC frequency content. Likewise, a filter between the NFC circuitry and the receive antenna should be configured to substantially attenuate or reject the wireless power frequency content. Some implementations to this effect are described in connection with FIGS. 4-13 below.

FIG. 4 illustrates a block diagram 400 of a dual mode antenna 402 and related communication and wireless power circuitry, in accordance with some implementations. As shown, the dual mode antenna 402 has a first terminal connected to a first switch 414 and a second terminal connected to a second switch 416. The switches 414, 416 are configured to selectively electrically connect the dual mode antenna 402 to an NFC portion or to a wireless power portion. When the switches 414, 416 are in a first position, the dual mode antenna 402 is electrically connected to an antenna tuning circuit 404, which is connected in series with NFC circuitry 406. When the switches 414, 416 are in a second position, the dual mode antenna 402 is electrically connected to wireless power circuitry 408, which may be configured to rectify and potentially process power received wireless by the dual mode antenna 402. A high impedance input (i.e., High-Z) detector 410 is connected across the first and second terminals of the dual mode antenna 402 and is configured to sense a frequency of a signal output from the dual mode antenna 402. When the high impedance detector 410 detects a first frequency (e.g., 6.78 MHz), it outputs a signal to a mode switch logic 412, which provides a control signal to each of the switches 414, 416 such that the switches 414, 416 connect the dual mode antenna 402 to the wireless power circuitry 408. When the high impedance detector 410 does not detect the first frequency, or when the high impedance detector 410 detects a second frequency (e.g., 13.56 MHz), it outputs a different signal to the mode switch logic 412, which provides a different control signal to each of the switches 414, 416 such that the switches 414, 416 connect the dual mode antenna 402 to the antenna tuning circuitry 404 and the NFC circuitry 406. The mode switch logic 412 may also be configured to communicate with each of the wireless power circuitry 408 and the NFC circuitry 406. Advantages of such implementations are that the dual mode antenna 402 may be larger than if separate antennas were used, which may provide a higher quality signal and/or which may receive wireless power or communicate over larger distances. However, such implementations may require increased design effort and may also provide reduced flexibility for NFC antenna placement.

FIG. 5 illustrates a hybrid schematic/block diagram 500 of a dual mode antenna and related communication and wireless power circuitry, in accordance with some implementations. As shown, a dual mode antenna (similar to that shown in FIG. 4) is shown as an equivalent circuit comprising a voltage source 520, an inductor 522 and a resistor 524, each connected in series. The voltage source 520 may represent a voltage induced in the dual mode antenna under the influence of an alternating magnetic field. The inductor 522 may represent the intrinsic inductance of the dual mode antenna. The resistor 524 may represent the intrinsic resistance of the dual mode antenna. FIG. 5 also shows a pre-matching network 514 connected in series with the dual mode antenna equivalent circuit. NFC circuitry 506 and wireless power circuitry 508 are each connected in parallel with one another and in series with an output of the pre-matching network 514. In such implementations, the pre-matching network 514 may provide electromagnetic interference filtering for both the NFC circuitry 506 and the wireless power circuitry 508. Implementations as shown in FIG. 5 may remove a need for switches and therefore have no losses in switches.

In some implementations, it may be desirable to realize a design that does not utilize the switches 414, 416 while providing matching networks having low pass filters and/or notch filters for reducing EMI as well as for neutralizing issues that may arise due to the parallel connection of the NFC and wireless power circuitries to a dual mode antenna.

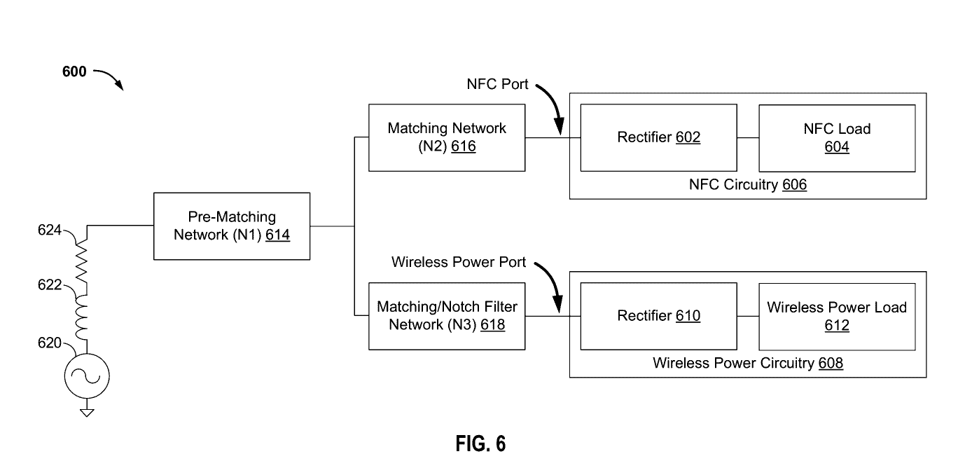

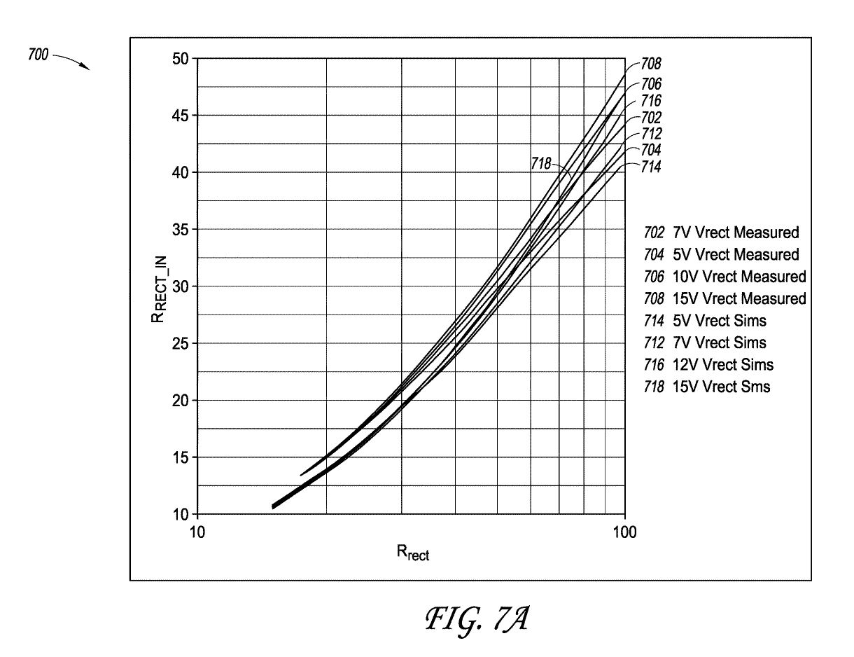

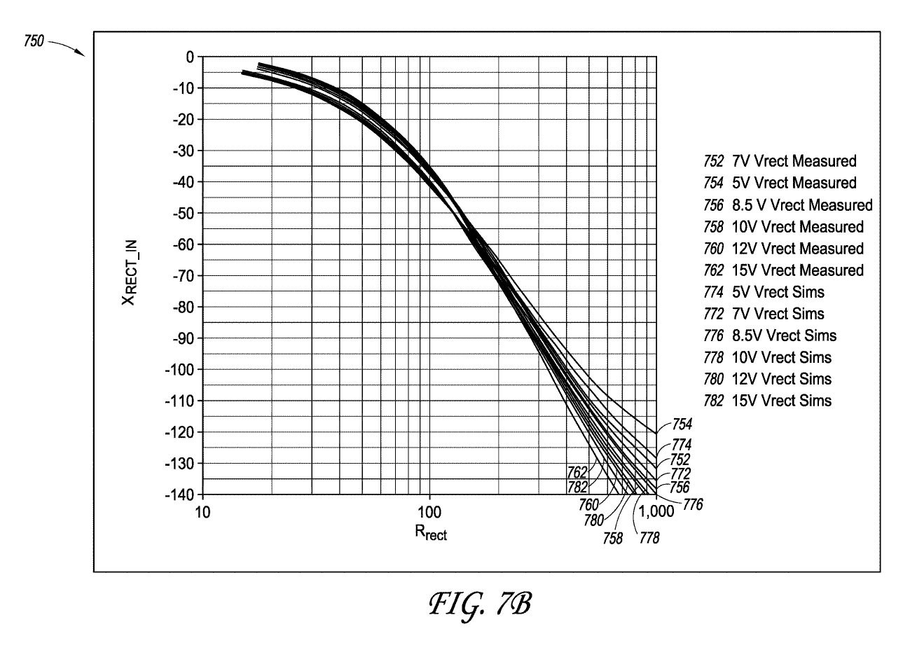

FIG. 6 illustrates another hybrid schematic/block diagram 600 of a dual mode antenna and related communication and wireless power circuitry, in accordance with some implementations. As shown, a dual mode antenna (similar to that shown in FIG. 4) is shown as an equivalent circuit comprising a voltage source 620, an inductor 622 and a resistor 624, each connected in series. The voltage source 620 may represent a voltage induced in the dual mode antenna under the influence of an alternating magnetic field. The inductor 622 may represent the intrinsic inductance of the dual mode antenna. The resistor 624 may represent the intrinsic resistance of the dual mode antenna. FIG. 6 also shows a pre-matching network 614 connected in series with the dual mode antenna equivalent circuit. A matching network 616 may be connected in series with an output of the pre-matching network 614. An output of the matching network 616 may be connected in series with NFC circuitry 606, which may include a rectifier 602 connected in series with an NFC load 604. In some implementations, the NFC load 604 may provide an exemplary load of 1 KΩ to 10 kΩ at a voltage of 2.5V, though other load resistances and voltages are contemplated. The matching network 616 may be configured to match the impedance of the NFC circuitry 606 to the impedance of the dual mode antenna and pre-matching network 614 as well as configured to block signals received from the pre-matching network 614 that are outside an operating frequency range of the NFC load 604 (e.g., signal content at frequencies associated with wireless power circuitry 608, for example 6.78 MHz).

A matching network or notch filter 618 may be connected in series with the output of the pre-matching network 614 (e.g., in parallel with the matching network 616). An output of the matching network or notch filter 618 may be connected in series with the wireless power circuitry 608, which may include a rectifier 610 connected in series with a wireless power load 612. In some implementations, the wireless power load 612 may provide an exemplary load of 10Ω to 50Ω at a voltage of 9V, though other load resistances and voltages are contemplated. The matching network 618 may be configured to block signals received from the pre-matching network 614 that are outside an operating frequency range of the wireless power load 612 (e.g., signal content at frequencies associated with NFC circuitry 606, for example 13.56 MHz).

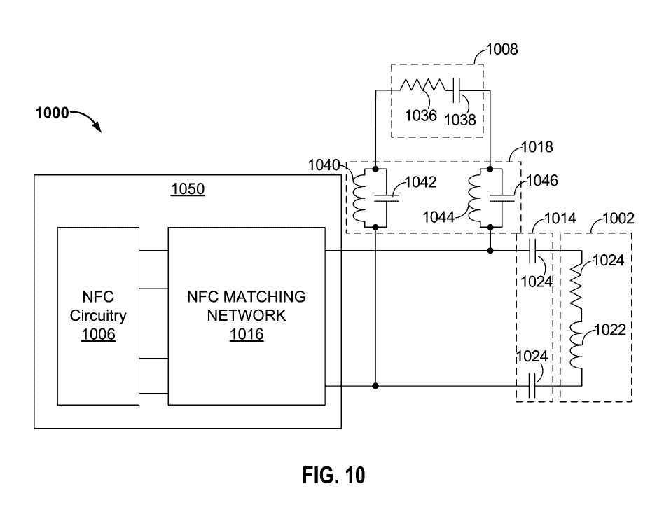

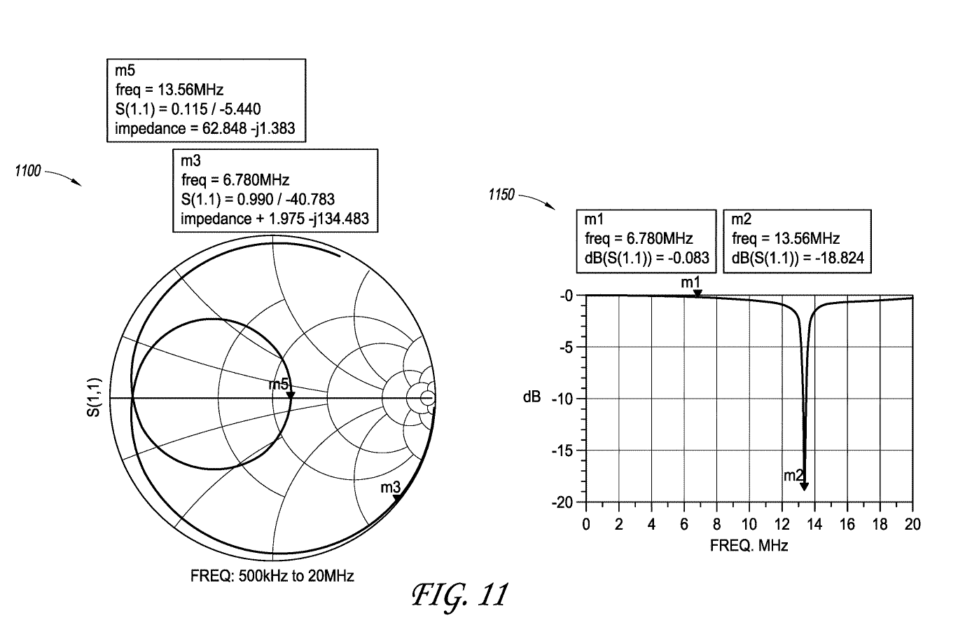

In some implementations, each of the pre-matching network 614, the matching network 616 and the matching/notch filter 618 may be configured to have different impedance characteristics at each of a first frequency associated with operation of the wireless power circuitry 608 (e.g., 6.78 MHz) and a second frequency associated with operation of the NFC circuitry 606 (e.g., 13.56 MHz). For example, in some implementations, the pre-matching network 614 may be configured to present an impedance of substantially 0Ω at the first frequency (e.g., 6.78 MHz) and an impedance optimized for NFC operation at the second frequency (e.g., 13.56 MHz). In some implementations, the matching network 616 may be configured to present a very high impedance (e.g., substantially infinity S2) at the first frequency (e.g., 6.78 MHz) and an impedance optimized for NFC operation at the second frequency (e.g., 13.56 MHz). In this way, the matching filter 616 may isolate the shunt path provided by the NFC circuitry 606 from the matching/notch filter 618 and the wireless power circuitry 608 at the first frequency (e.g., 6.78 MHz). In some implementations, the matching/notch filter 618 may be configured to present an optimized impedance for wireless power transfer operation at the first frequency (e.g., 6.78 MHz) and a very high impedance (e.g., greater than 100, 1 k, 10 k, 100 k or 1 MΩ) at the second frequency (e.g., 13.56 MHz). In this way, the matching/notch filter 618 may isolate the shunt path provided by the wireless power circuitry 608 from the matching network 616 and the NFC circuitry 606 at the second frequency (e.g., 13.56 MHz). For the purposes of this application, the term “isolate” or “electrically isolate” may be considered to mean presenting a substantially larger impedance in the isolating condition than in other or non-isolating conditions. For example, the notch filter 618 may be configured to provide an impedance greater than 100Ω, greater than 1 kΩ, greater than 10 kΩ, greater than 100 kΩ or greater than 1 MΩ at 13.56 MHz, while presenting an impedance of approximately 0Ω (e.g., less than 10, 5, or 1Ω) at 6.78 MHz. In this way, the notch filter 618, as well as similar filters described herein such as in FIG. 10, may provide such a large impedance in the isolated state that substantially no current will flow through the notch filter 618. Thus, an effect similar to that of an open switch may be achieved without the losses or manufacturing costs associated with such switches.

FIG. 7A illustrates a graph 700 of a rectifier resistance R_{RECT}_{_}_{IN} as a function of a load resistance R_{RECT}, in accordance with some implementations. As shown in FIG. 7A, the rectifier resistance R_{RECT}_{_}_{IN} increases as the load resistance R_{RECT} increases for each of several voltages measured (dotted lines) and simulated (solid lines) at an output of the rectifier (e.g., the rectifier 610 within the wireless power circuitry 608 shown in FIG. 6). As shown, lines 702, 704, 706 and 708 represent measured values of the load resistance R_{RECT}_{_}_{IN} at 7V, 5V, 10V, and 15V respectively, while lines 712, 714, 716 and 718 represent simulated values of the load resistance R_{RECT}_{_}_{IN} at 5V, 7V, 10V and 15V, respectively.

FIG. 7B illustrates a graph 750 of a rectifier reactance x_{RECT}_{_}_{IN} as a function of a load resistance R_{RECT}, in accordance with some implementations. As shown in FIG. 7B, the rectifier reactance X_{RECT}_{_}_{IN} decreases as the load resistance R_{RECT} increases for each of several voltages measured (dotted lines) and simulated (solid lines) at an output of the rectifier (e.g., the rectifier 610 within the wireless power circuitry 608 shown in FIG. 6). As shown, lines 752, 754, 756, 758, 760 and 762 represent measured values of the load reactance X_{RECT}_{_}_{IN} at 7V, 5V, 8.5V, 10V, 12V and 15V, respectively, while lines 772, 774, 776, 778, 780 and 782 represent simulated values of the load reactance X_{RECT}_{_}_{IN} at 5V, 7V, 8.5V, 10V, 12V and 15V, respectively.

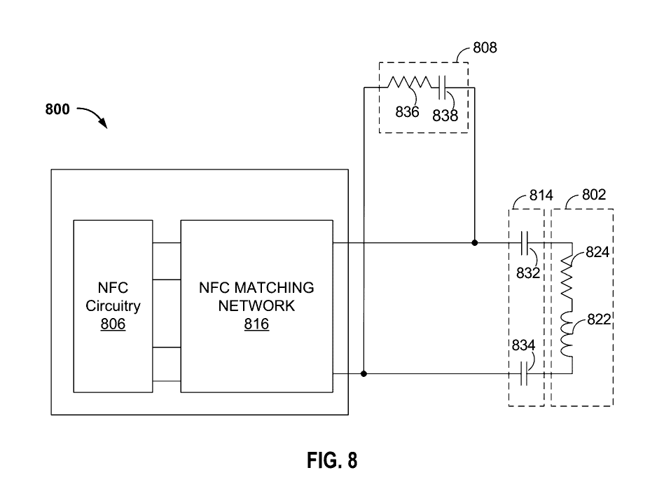

Because the resistance is always positive and the reactance is always negative, the input impedance of the wireless power circuitry 608 (see FIG. 6) looking into the rectifier 610 from the “wireless power port” may be modeled as a resistor in series with a capacitor, as will be described in more detail in connection with FIGS. 8-11 below.

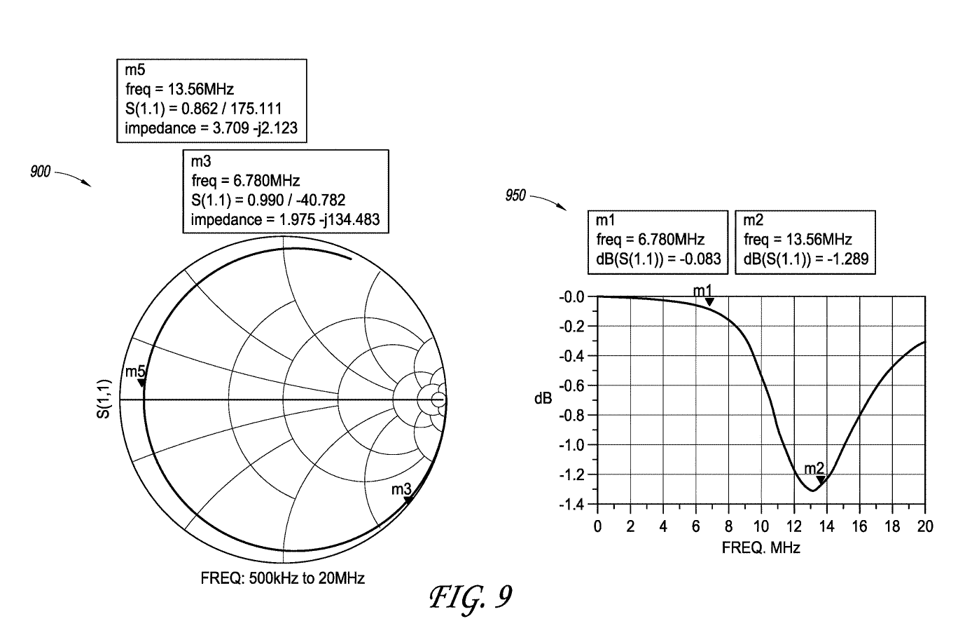

FIG. 8 illustrates another hybrid schematic/block diagram 800 of a dual mode antenna and related communication and wireless power circuitry, in accordance with some implementations. As shown, a dual mode antenna 802 is shown as an equivalent circuit comprising a resistor 824 electrically connected in series with an inductor 822. The resistor 824 may represent the intrinsic resistance of the dual mode antenna 802, while the inductor 822 may represent the intrinsic inductance of the dual mode antenna 802. The terminals of the dual mode antenna 802 are electrically connected to a pre-matching network 814, which may comprise a first capacitor 832 connected in series with a first terminal of the dual mode antenna 802 and a second capacitor 834 connected in series with a second terminal of the dual mode antenna 802. In some implementations, the pre-matching network 814 may correspond to the pre-matching network 614 previously described in connection with FIG. 6. An output of the pre-matching network 614 may be connected to an input of each of an NFC matching network 816 and a wireless power circuitry 808. The NFC matching network 816 may correspond to the matching network 616 previously described in connection with FIG. 6, while the wireless power circuitry 808 may correspond to the wireless power circuitry 608 of FIG. 6. An output of the NFC matching network 816 may be electrically connected to an input of NFC circuitry 806, which may correspond to the NFC circuitry 606 previously described in connection with FIG. 6. When the NFC circuitry 806 is active (e.g., when a signal received and output by the dual mode antenna 802 oscillates at the second frequency, for example 13.56 MHz) charging via the wireless power circuitry 808 may be disabled. Thus, the resistance of the rectifier 610 within the wireless power circuitry 608 will be near open circuit. For this reason, and as previously described in connection with FIGS. 7A and 7B, the wireless power circuitry 608 may be modeled as a resistor 836 connected in series with a capacitor 838. In some implementations, the resistor 836 may have a value of 100Ω, though other resistances are contemplated depending on the specific implementation. Likewise, in some implementations, the capacitor 838 may have a value of 332 pF (equal to −j140Ω at 6.78 MHz), though other reactances are contemplated. However, as will be described in connection with FIG. 9, the implementation shown in FIG. 8 results in very poor NFC matching at the second frequency (e.g., 13.56 MHz) due to the influences of the wireless power circuitry 808.

FIG. 9 illustrates an impedance versus frequency curve 900 and a frequency response curve 950 for the NFC matching network shown in FIG. 8, in accordance with some implementations. The curve 900 shows the complex impedance of the NFC matching network 816, while the curve 950 shows the frequency response of a signal at the output of the pre-matching network 814. As shown, the rejection of the second frequency (e.g., 13.56 MHz) is a mere −1.289 dB. This effect may be attributed at least in part to the effect of the shunt path provided by the wireless power circuitry 808 at the second frequency (e.g., 13.56 MHz) when the wireless power circuitry 808 is not properly isolated from the NFC matching network 816 and the NFC circuitry 806.

FIG. 10 illustrates another hybrid schematic/block diagram 1000 of an antenna and related communication and wireless power circuitry, in accordance with some implementations. As shown, an antenna 1002 is shown as an equivalent circuit comprising a resistor 1024 electrically connected in series with an inductor 1022. The resistor 1024 may represent the intrinsic resistance of the antenna 1002, while the inductor 1022 may represent the intrinsic inductance of the antenna 1002. The terminals of the antenna 1002 are electrically connected to a first matching circuit 1014, which may comprise a first capacitor 1032 connected in series with a first terminal of the antenna 1002 and a second capacitor 1034 connected in series with a second terminal of the antenna 1002. In some implementations, the first matching circuit 1014 may correspond to the pre-matching network 614 previously described in connection with FIG. 6. An output of the first matching circuit 1014 may be connected to an input of each of a second matching network 1016 and a filter circuit 1018. The second matching circuit 1016 may correspond to the matching network 616 previously described in connection with FIG. 6. An output of the second matching circuit 1016 may be electrically connected to an input of the communication circuitry 1006, which may correspond to the NFC circuitry 606 previously described in connection with FIG. 6. The filter circuit 1018 may comprise a first inductor 1044 in parallel with a first capacitor 1046 and a second inductor 1040 in parallel with a second capacitor 1042. The first inductor 1044 and the first capacitor 1046 may be connected between a first output terminal of the first matching circuit 1014 and a first terminal of wireless power circuitry 1008. The second inductor 1040 and the second capacitor 1042 may be connected between a second output terminal of the first matching circuit 1014 and a second terminal of wireless power circuitry 1008. The filter circuit 1018 may be a notch filter The wireless power circuitry 1008 may correspond to the wireless power circuitry 608 of FIG. 6.

When the communication circuitry 1006 is active (e.g., when a signal output by the antenna 1002 oscillates at the second frequency, for example 13.56 MHz) charging via the wireless power circuitry 1008 may be disabled. Thus, the resistance of the rectifier 610 within the wireless power circuitry 608 will be near open circuit. For this reason, and as previously described in connection with FIGS. 7A and 7B, the wireless power circuitry 608 may be modeled as a resistor 1036 connected in series with a capacitor 1038. In some implementations, the resistor 1036 may have a value of 100Ω, though other resistances are contemplated depending on the specific implementation. Likewise, in some implementations, the capacitor 1038 may have a value of 332 pF (equal to −j140Ω at 6.78 MHz), though other reactances are contemplated. As will be described in connection with FIG. 11, the implementation shown in FIG. 10 results in excellent NFC matching at the second frequency (e.g., 13.56 MHz) due to the isolation of the wireless power circuitry 1008 by the filter circuit 1018.

FIG. 11 illustrates impedance versus frequency curves 1100, 1150 for the NFC matching network shown in FIG. 10, in accordance with some implementations. The curve 1100 shows the complex impedance of the second matching circuit 1016, while the curve 1150 shows the frequency response of a signal at the output of the first matching circuit 1014. As shown, the rejection of the second frequency (e.g., 13.56 MHz) is a much greater −18.824 dB. This effect may be attributed at least in part to the isolating effect the notch filter 1018 provides at the second frequency (e.g., 13.56 MHz) between the shunt path provided by the wireless power circuitry 1008 and the second matching circuit 1016 and the communication circuitry 1006. Thus, the filter 1018 effectively isolates the wireless power circuitry 1008 from the communication circuitry 1006 at the second frequency (e.g., 13.56 MHz), while presenting a substantially 0Ω impedance at the first frequency (e.g., 6.78 MHz).

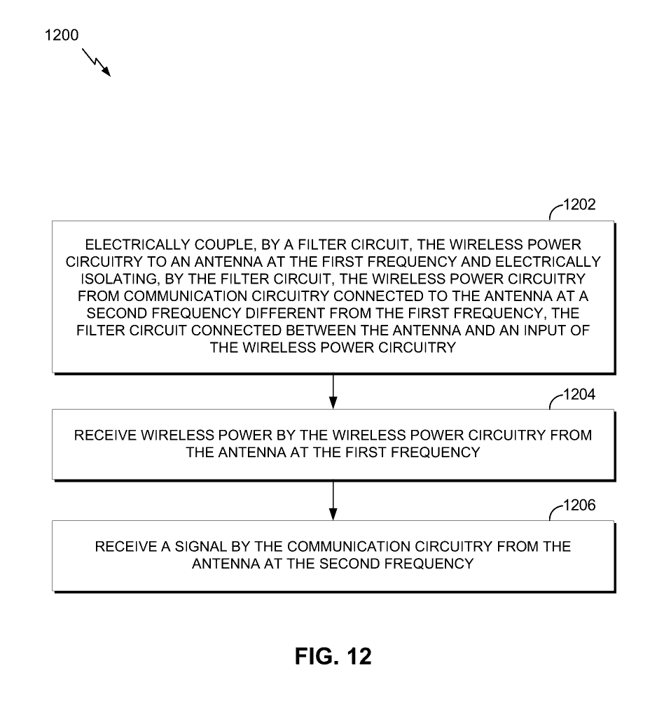

FIG. 12 is a flow chart 1200 for a method for wirelessly coupling an electronic device with other devices, in accordance with some implementations. Although blocks may be described as occurring in a certain order, the blocks can be reordered, blocks can be omitted, and/or additional blocks can be added.

The flowchart 1200 may begin with block 1202, which includes electrically coupling, by a filter circuit, wireless power circuitry to an antenna at a first frequency and electrically isolating, by the filter circuit, the wireless power circuitry from communication circuitry coupled to the antenna at a second frequency different from the first frequency. The filter circuit is coupled between the antenna and an input of the wireless power circuitry. For example, the apparatus of FIG. 10 may further comprise a filter circuit 1018 coupled between the antenna 1002 and an input of the wireless power circuitry 1008. The filter circuit is configured to electrically connect the wireless power circuitry 1008 to the antenna 1002 at the first frequency and electrically isolate the wireless power circuitry 1008 from the communication circuitry 1050 at the second frequency. In some implementations, the filter circuit 1018 may also be known as, or may comprise at least a portion of means for electrically coupling the means for receiving wireless power to the means for generating a voltage and electrically isolating the means for receiving wireless power from the means for receiving the signal at the second frequency. The means for electrically coupling is connected between the means for generating a voltage and an input of the means for receiving wireless power.

The flowchart 1200 may continue with block 1204, which includes receiving wireless power by the wireless power circuitry from the antenna at the first frequency. For example, the wireless power circuitry 1008 is configured to receive wireless power from the antenna 1002 at a first frequency.

The flowchart 1200 may continue with block 1206, which includes receiving a signal by the communication circuitry from the antenna at the second frequency. For example, the communication circuitry 1050 is configured to receive a signal from the antenna 1002 at a second frequency different from the first frequency.

In some implementations, the filter circuit 1018 provides a substantially closed circuit at the first frequency and a substantially open circuit at the second frequency. The filter circuit 1018 is configured to electrically isolate the wireless power circuitry 1008 from the first matching circuit 1014 and the antenna 1002 at the second frequency. The antenna 1002 comprises a first terminal and a second terminal and the first matching circuit 1014 comprises a first capacitor connected in series with the first terminal and a second capacitor connected in series with the second terminal. The filter circuit 1018 comprises a notch filter including at least a first inductor 1044 in parallel with a first capacitor 1046. The communication circuitry 1050 comprises a second matching circuit 1016 configured to match a third impedance of the communication circuitry 1050 to a fourth impedance of the antenna 1002 at the second frequency. The second matching circuit 1016 is further configured to substantially electrically isolate the communication circuitry 1006 from the antenna 1002 at the first frequency. The communication circuitry 1006 comprises near field communication circuitry.

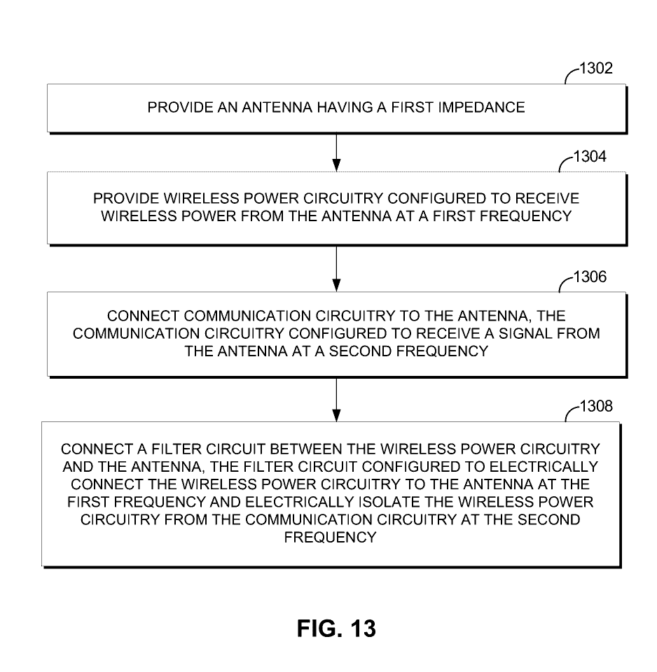

FIG. 13 is a flow chart 1300 for a method for manufacturing an electronic device for wirelessly coupling with other devices, in accordance with some implementations. Although blocks may be described as occurring in a certain order, the blocks can be reordered, blocks can be omitted, and/or additional blocks can be added.

The flowchart 1300 may begin with block 1302, which includes providing an antenna having a first impedance. For example, as shown in FIG. 10, an apparatus for wirelessly coupling with other devices may comprise an antenna 1002.

The flowchart 1300 may continue with block 1304, which includes providing wireless power circuitry configured to receive wireless power from the antenna at a first frequency. For example, the apparatus of FIG. 10 may further comprise wireless power circuitry 1008.

The flowchart 1300 may continue with block 1306, which includes connecting communication circuitry to the antenna, the communication circuitry configured to receive a signal from the antenna at a second frequency. For example, the apparatus of FIG. 10 includes communication circuitry 1050 connected to the antenna 1002.

The flowchart 1300 may continue with block 1308, which includes connecting a filter circuit between the wireless power circuitry and the antenna, the filter circuit configured to electrically connect the wireless power circuitry to the antenna at the first frequency and electrically isolate the wireless power circuitry from the communication circuitry at the second frequency. For example, the apparatus of FIG. 10 includes the filter circuit 1018 connected between the wireless power circuitry 1008 and the antenna 1002.

A person/one having ordinary skill in the art would understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. An apparatus for wirelessly coupling with other devices, comprising:
an antenna;
wireless power circuitry configured to receive wireless power from the antenna at a first frequency;
communication circuitry coupled to the antenna and configured to receive a signal from the antenna at a second frequency different from the first frequency; and
a filter circuit coupled between the antenna and an input of the wireless power circuitry, the filter circuit configured to electrically connect the wireless power circuitry to the antenna at the first frequency and electrically isolate the wireless power circuitry from the communication circuitry at the second frequency.

2. The apparatus of claim 1, wherein the filter circuit provides a substantially closed circuit at the first frequency and a substantially open circuit at the second frequency.

3. The apparatus of claim 1, further comprising:
a first matching circuit connected to an output of the antenna and configured to match a first impedance of the wireless power circuitry to a second impedance of the antenna at the first frequency;
wherein the filter circuit is configured to electrically isolate the wireless power circuitry from the first matching circuit, the antenna, and the communication circuitry at the second frequency.

4. The apparatus of claim 3, wherein the output of the antenna comprises a first terminal and a second terminal and wherein the first matching circuit comprises a first capacitor connected in series with the first terminal and a second capacitor connected in series with the second terminal.

5. The apparatus of claim 1, wherein the filter circuit comprises a notch filter including at least a first inductor in parallel with a first capacitor.

6. The apparatus of claim 1, wherein the communication circuitry comprises a second matching circuit configured to match a third impedance of the communication circuitry to a fourth impedance of the antenna at the second frequency.

7. The apparatus of claim 6, wherein the second matching circuit is further configured to substantially electrically isolate the communication circuitry from the antenna at the first frequency.

8. The apparatus of claim 1, wherein the communication circuitry comprises near field communication circuitry.

9. A method for wirelessly coupling an electronic device with other devices, comprising:
electrically coupling, by a filter circuit, wireless power circuitry to an antenna at a first frequency and electrically isolating, by the filter circuit, the wireless power circuitry from communication circuitry coupled to the antenna at a second frequency different from the first frequency, the filter circuit coupled between the antenna and an input of the wireless power circuitry;
receiving wireless power by the wireless power circuitry from the antenna at the first frequency; and
receiving a signal by the communication circuitry from the antenna at the second frequency.

10. The method of claim 9, wherein the filter circuit provides a substantially closed circuit at the first frequency and a substantially open circuit at the second frequency.

11. The method of claim 9, further comprising:
matching, by a first matching circuit connected to the antenna, a first impedance of the wireless power circuitry to a second impedance of the antenna at the first frequency;
wherein the filter circuit is configured to electrically isolate the wireless power circuitry from the first matching circuit, the antenna, and the communication circuitry at the second frequency.

12. The method of claim 11, wherein the output of the antenna comprises a first terminal and a second terminal and wherein the first matching circuit comprises a first capacitor connected in series with the first terminal and a second capacitor connected in series with the second terminal.

13. The method of claim 9, wherein the filter circuit comprises a notch filter including at least a first inductor in parallel with a first capacitor.

14. The method of claim 9, wherein the communication circuitry comprises a second matching circuit, the method further comprising matching a third impedance of the communication circuitry to a fourth impedance of the antenna at the second frequency by the second matching circuit.

15. The method of claim 14, further comprising electrically isolating the communication circuitry from the antenna at the first frequency by the second matching circuit.

16. The method of claim 9, wherein the communication circuitry comprises near field communication circuitry.

17. A method for manufacturing an electronic device for wirelessly coupling with other devices, comprising:
providing an antenna;
providing wireless power circuitry configured to receive wireless power from the antenna at a first frequency;
connecting communication circuitry to the antenna, the communication circuitry configured to receive a signal from the antenna at a second frequency; and
connecting a filter circuit between the wireless power circuitry and the antenna, the filter circuit configured to electrically connect the wireless power circuitry to the antenna at the first frequency and electrically isolate the wireless power circuitry from the communication circuitry at the second frequency.

18. The method of claim 17, wherein the filter circuit provides a substantially closed circuit at the first frequency and a substantially open circuit at the second frequency.

19. The method of claim 17, further comprising:
connecting a first matching circuit to the antenna, the first matching circuit configured to match a first impedance of the wireless power circuitry to a second impedance of the antenna at the first frequency;
wherein the filter circuit is configured to electrically isolate the wireless power circuitry from the first matching circuit, the antenna, and the communication circuitry at the second frequency.

20. The method of claim 19, wherein the antenna comprises a first terminal and a second terminal and wherein the first matching circuit comprises a first capacitor connected in series with the first terminal and a second capacitor connected in series with the second terminal.

21. The method of claim 17, wherein the filter circuit comprises a notch filter including at least a first inductor in parallel with a first capacitor.

22. The method of claim 17, wherein the communication circuitry comprises a second matching circuit configured to match a third impedance of the communication circuitry to a fourth impedance of the antenna at the second frequency.

23. The method of claim 22, wherein the second matching circuit is configured to electrically isolate the communication circuitry from the antenna at the first frequency.

24. The method of claim 17, wherein the communication circuitry comprises near field communication circuitry.

25. An apparatus for wirelessly coupling with other devices, comprising:
means for generating a voltage under the influence of an alternating magnetic field;
means for receiving wireless power at a first frequency from the means for generating the voltage;
means for receiving a signal from the means for generating the voltage at a second frequency different from the first frequency; and
means for electrically connecting the means for receiving wireless power to the means for generating a voltage at the first frequency and electrically isolating the means for receiving wireless power from the means for receiving the signal at the second frequency, the means for electrically connecting connected between the means for generating a voltage and an input of the means for receiving wireless power.

26. The apparatus of claim 25, wherein the means for electrically connecting provides a substantially closed circuit at the first frequency and a substantially open circuit at the second frequency.

27. The apparatus of claim 25, further comprising:
first means for matching a first impedance of the means for receiving wireless power to a second impedance of the means for generating the voltage at the first frequency;
wherein the means for electrically connecting is configured to electrically isolate the means for receiving wireless power from the first means for matching, the means for generating the voltage, and the means for receiving the signal at the second frequency.

28. The apparatus of claim 27, wherein an output of the means for generating the voltage comprises a first terminal and a second terminal and wherein the first means for matching comprises a first capacitor connected in series with the first terminal and a second capacitor connected in series with the second terminal.

29. The apparatus of claim 25, wherein the means for receiving the signal comprises a second means for matching configured to match a third impedance of the means for receiving the signal to a fourth impedance of the means for generating the voltage at the second frequency.

30. The apparatus of claim 29, wherein the second means for matching is further configured to substantially electrically isolate the means for receiving the signal from the means for generating the voltage at the first frequency.
